(19) United States
(12) Patent Application Publication
(10) Pub. No.: US 2018/0079591 A1
(43) Pub. Date: Mar. 22, 2018

(54) AUTOMATED TRASH CART

(71) Applicant: JACKSON STATE UNIVERSITY, JACKSON, MS (US)

(72) Inventors: Charles Doty, Jackson, MS (US); Kamal S Ali, Jackson, MS (US)

(73) Assignee: JACKSON STATE UNIVERSITY, JACKSON, MS (US)

(21) Appl. No.: 15/708,879

(22) Filed: Sep. 19, 2017

Related U.S. Application Data
(60) Provisional application No. 62/396,330, filed on Sep. 19, 2016.

(51) Int. Cl. B65F 1/14; G05D 1/02; H04W 4/04

(52) U.S. Cl. CPC B65F 1/1473; G05D 1/0242; B65F 2210/165; H04W 4/046; G05D 1/0278

(57) ABSTRACT

An automated trash cart that transports trash, recycling, and other waste (“waste”) from a home station to a designated pickup station along a designated route when instructed by a user via a smart mobile device. After the waste is picked up, the automated trash cart returns along the designated route to the home station. The automated trash cart comprises a cart, onboard microcontroller, network connection, such as Wi-Fi, Bluetooth or cellular, and other sensors. The onboard microcontroller software is accessible online via smart device applications. The automated trash cart navigates autonomously, alerts the user if there are obstacles in its designated route, and charges itself while at home station. Once programmed, the device is capable of numerous ancillary functions such as opening and closing garage doors as needed to travel along the designated route as per user instructions and programming.

### CROSS-REFERENCE TO RELATED APPLICATIONS

This application claims priority to U.S. Provisional Application No. 62/396,330 to Charles Doty, et al. filed on Sep. 19, 2016, the contents of which are incorporated herein by reference in its entirety.

### FIELD OF THE INVENTION

The present invention is generally directed toward an autonomous vehicle, and more specifically to an autonomous platform vehicle for delivering and/or retrieving waste and/or waste containers.

### BACKGROUND OF THE INVENTION

Trash is created in the majority of households and businesses across America and collected by cities as a public service. The trash that is created in and around a dwelling or business must be collected and deposited in a receptacle and placed in a designated location to receive pickup services. The designated locations usually reside on the side of the road or alley way a distance away from the indoors to facilitate pick up by the trash service. Moving the trash in the receptacle to the designated pick up location is burdensome and can be difficult for some classes of people due to numerous factors, such as, weight, distance, crime, topography, etc. There is a need for a solution to these problems in the field.

### SUMMARY OF THE INVENTION

An automated trash cart is provided as a mobile platform that is accessible online. The platform transports trash, recycling, and other waste (“waste”) from a home station to a designated pickup station along a designated route, for example at a curbside location. After the waste is picked up, the platform returns along the designated route to the home station, hence, automating the task of moving waste for pickup. The platform is accessible online and via smart device applications. It navigates autonomously to the designated pickup station, and returns after waste has been removed from the platform. The platform is capable of alerting a user if there are obstacles on its path. The platform charges itself while at home station. This charging may optionally be solar powered. Once programmed, the device is completely autonomous and is capable of numerous ancillary functions such as opening and closing garage doors as needed to travel along the designated route as per user instructions and programming.

### BRIEF DESCRIPTION OF THE DRAWINGS

Further advantages of the invention will become apparent by reference to the detailed description of preferred embodiments when considered in conjunction with the drawings:

FIG. 1 depicts a top plan view of an exemplary designated route for the platform with home station and pickup station in relation to building, driveway, and right of way.

FIG. 2 is an exemplary embodiment of the platform at a designated pickup station.

### DETAILED DESCRIPTION

The following detailed description is presented to enable any person skilled in the art to make and use the invention. For purposes of explanation, specific details are set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to one skilled in the art, and the general principles defined herein may be applied to other embodiments and applications without departing from the scope of the invention. The present invention is not intended to be limited to the embodiments shown, but is to be accorded the widest possible scope consistent with the principles and features disclosed herein.

The process of taking out the trash is time consuming and effort intensive and can be difficult for elderly people and those with physical disabilities. The designated route 3 of the trash 2 from the place of residence or commercial property 7 to the pickup location 5 may contain obstacles and/or be a far distance, which can place the individual taking out the trash vulnerable to crime and inclement weather. The present invention discloses an automated trash cart 1 on a mobile platform that transports waste 2 from a home station 4 to a pickup location 5 along a designated route 3 alleviating the difficulties associated with individuals taking out the waste 2.

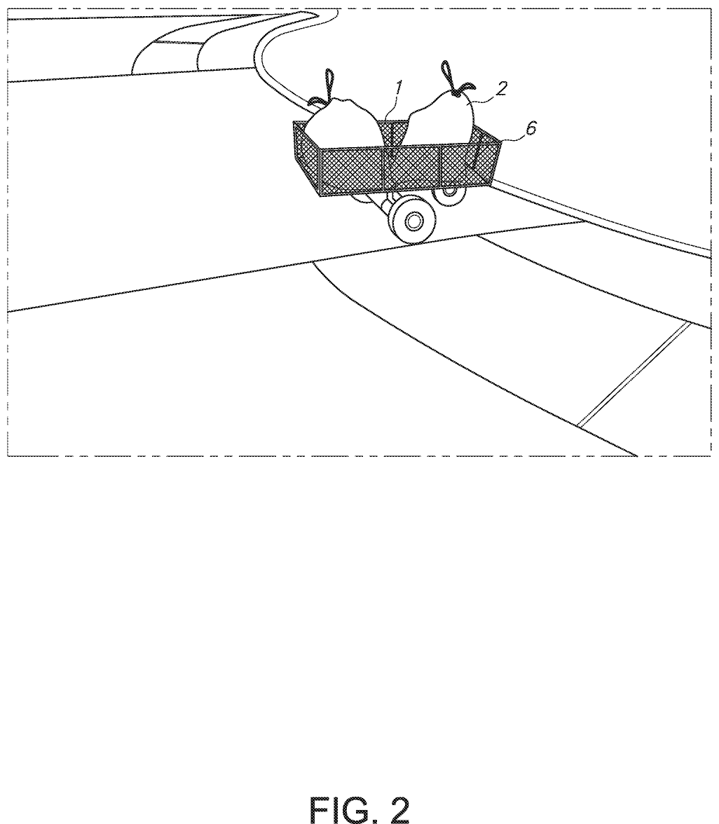

In the preferred embodiment, the automated trash cart 1 is comprised of a cart 6, onboard microcontroller, a network connection, and one or more of a variety of sensors. The cart 6, as shown in FIG. 2, is any vessel capable of containing and transporting waste 2. The onboard microcontroller software is compatible with programs on smart mobile devices, such as phones, pads and PCs and is accessible via Wi-Fi, cellular and Bluetooth connections as a mobile device application. The sensors include ultrasonic, strain, IR, vision, mass/weight scale, and GPS sensors. The platform is accessed online via a secure link for programming status verification. The automated trash cart 1 can be programmed for the following instructions and tasks:
1. When to move from the home station 4 to the pickup station 5 along the designated route 3 (days and times, as well as any deviations).
2. How long to wait after waste 2 is removed from the automated trash cart 1 before returning to the home station 4 (or a secondary destination) along the designated route 3 or alternative designated route.
3. How long to wait if no waste 2 is removed from the automated trash cart 1 before notifying the user over a network connection.
4. When to perform ancillary functions, such as when to activate a garage door for opening and closing, as well as when to not do such functions (day and time, etc.).
5. Obstacle notification via message alerts to a user using the network using various available modes (text message, email, via cellular connection, internet connection, etc.).

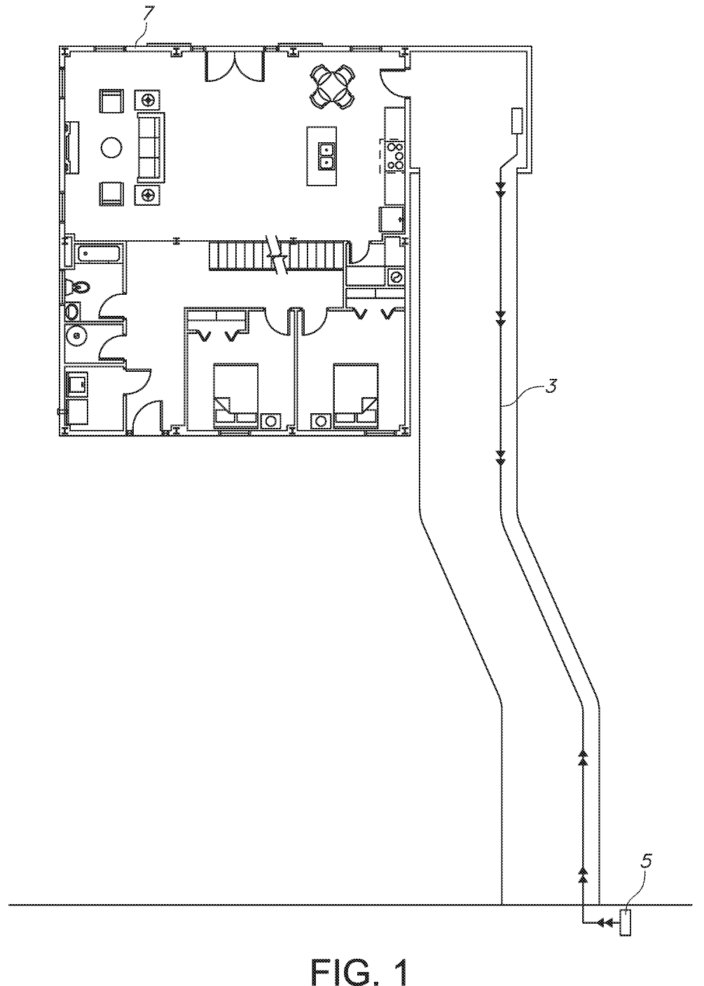

After the microcontroller software is downloaded by a user, the user designates the route for the waste 2, which is picked up from the home station 4 and transported autonomously along the designated route 3 to the pickup location 5, as shown in FIG. 1. The automated trash cart 1 will autonomously navigate along a designated route(s) 3 from the home station to a designated pickup station 5 (e.g., a curbside pickup location) and back by using one of several techniques. These include, but are not limited to:
1. Line following sensors (Using IR or any other electromagnetic wavelength reflection along a designated path).
2. Electromagnetic field sensing, such as following an energized wire or magnetic field signal.
3. Using GPS augmented with “vision” (e.g., sound echo, vision-based sensors and algorithms, etc.).
4. Other compatible navigation techniques.
   The automated trash cart 1 uses the selected technique to navigate along the designated route 3 from home station 4 to pickup station 5 and back, at the appropriate designated times.

After the waste 2 is picked up at the pickup location, the automated trash cart returns along the designated route to the home station, hence, automating the task of moving waste for pickup. The automated trash cart is capable of alerting a user if there are obstacles on the designated route. The automated trash cart 1 will use ultrasonic and/or IR (or other frequency light sensors) to detect obstacles along the designated route(s) 3. When an obstacle is detected, the user is notified to remedy the situation. The automated trash cart 1 may be programmed for self-help, such as to go around obstacles, as an added feature and when such is possible.

The automated trash cart is battery powered. The battery will be charged while at the home station 4. This can be done by induction or any other charging means known in the field of remote and/or autonomous vehicle, such as via solar power.

The preferred use of the automated trash cart 1 is in urban environments, where the distance is small between the home station 4 and the designated pickup station 5, and also where Wi-Fi or other communication frequencies and systems can be accessed throughout the operation range of the platform. In a preferred embodiment, the system will rely on Wi-Fi for all communications.

The system may also be configured to operate in rural areas where the distance between the home station 4 and the designated pickup station 5 is large and Wi-Fi may not be available throughout the operational range of the automated trash cart 1. In this situation, cellular communication may be used.

The automated trash cart 1 is equipped with a manual override, allowing the user to drive the automated trash cart 1 as needed. The security levels of all automated trash cart 1 communications are user defined, allowing the use of fully encrypted communications.

The market potential for the automated trash cart 1 is vast. Urban and rural communities alike will benefit from the safety and convenience of having to spend less time attending to the burdensome task of transporting waste 2 to a designated pickup location 5 and retrieving waste containers. Additionally, there is a substantial market which is poised for a product of this type. Environmental conditions, disabled individuals, and elderly persons also enhance the marketability of this innovative idea.

The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition or step being referred to is an optional (not required) feature of the invention.

The invention has been described with reference to various specific and preferred embodiments and techniques. However, it should be understood that many variations and modifications may be made while remaining within the spirit and scope of the invention. It will be apparent to one of ordinary skill in the art that methods, devices, device elements, materials, procedures and techniques other than those specifically described herein can be applied to the practice of the invention as broadly disclosed herein without resort to undue experimentation. All art-known functional equivalents of methods, devices, device elements, materials, procedures and techniques described herein are intended to be encompassed by this invention. Whenever a range is disclosed, all subranges and individual values are intended to be encompassed. This invention is not to be limited by the embodiments disclosed, including any shown in the drawings or exemplified in the specification, which are given by way of example and not of limitation.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

All references throughout this application, for example patent documents including issued or granted patents or equivalents, patent application publications, and non-patent literature documents or other source material, are hereby incorporated by reference herein in their entireties, as though individually incorporated by reference, to the extent each reference is at least partially not inconsistent with the disclosure in the present application (for example, a reference that is partially inconsistent is incorporated by reference except for the partially inconsistent portion of the reference).

We claim:

1. An automated trash cart for transporting waste comprising:
a. a cart;
b. onboard microcontroller;
c. network connection; and
d. sensors.

2. The network connection of claim 1 wherein said network connection is Wi-Fi.

3. The network connection of claim 1 wherein said network connection is Bluetooth.

4. The network connection of claim 1 wherein said network connection is cellular.

5. The sensors of claim 1 wherein said sensor is ultrasonic.

6. The sensors of claim 1 wherein said sensor is strain.

7. The sensors of claim 1 wherein said sensor is infrared.

8. The sensors of claim 1 wherein said sensor is vision.

9. The sensors of claim 1 wherein said sensor is mass/weight scale.

10. The sensors of claim 1 wherein said sensor is GPS.

11. The sensors of claim 1 wherein said sensor detects obstacles in the designated route of the automated trash cart.

12. The automated trash cart of claim 1 wherein said automated trash cart is battery powered.

13. The automated trash cart of claim 1 wherein said automated trash cart is solar powered.

14. The automated trash cart of claim 1 wherein said automated trash cart provides notification to the user.

15. The notification of claim 14 wherein said notification is of obstacles in the automated trash cart's path.

16. The automated trash cart of claim 1 wherein said automated trash cart controls garage doors.

17. A process for moving waste via an automated trash cart comprising:
a. downloading an application by a user on a compatible device;
b. the user providing instruction to the automated trash cart via the application;
c. the user placing the waste in the automated trash cart;
d. the automated trash cart transporting waste via the designated route from the home station to the pickup location; and
e. the automated trash cart transporting waste via the designated route from the pickup location to the home station after the waste has been removed.

18. The instruction of claim 17 wherein said instruction is when to move the waste from the home station to the pickup location.

19. The instruction of claim 17 wherein said instruction is the length of time to wait after the waste is removed before returning to the home station.

20. The instruction of claim 17 where said instruction is when to activate a garage door for opening and closing.

21. The network connection of claim 17 wherein said connection is Wi-Fi.

22. The network connection of claim 17 wherein said connection is Bluetooth.

23. The network connection of claim 17 wherein said connection is cellular.

24. The automated trash cart of claim 17 wherein said automated trash cart provides notification to the user.

25. The notification of claim 24 wherein said notification is of obstacles in the automated trash cart's path.

26. The automated trash cart of claim 17 wherein said automated trash cart controls garage doors.

27. The automated trash cart of claim 17 wherein said automated trash cart is battery powered.

28. The automated trash cart of claim 17 wherein said automated trash cart is solar powered.

29. The device of claim 17 wherein said device is a smart phone.

30. The device of claim 17 wherein said device is a tablet.

31. The device of claim 17 wherein said device is a PC.
